(19) United States
(12) Patent Application Publication
(10) Pub. No.: US 2009/0064202 A1
(43) Pub. Date: Mar. 5, 2009

(54) SUPPORT LAYER FOR ENABLING SAME ACCESSORY SUPPORT ACROSS MULTIPLE PLATFORMS

(75) Inventors: Jeffery T. Lee, Sunnyvale, CA (US); Skip Haughay, JR., San Jose, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(73) Assignee: Apple, Inc., Cupertino, CA (US)

(21) Appl. No.: 12/201,874

(22) Filed: Aug. 29, 2008

Related U.S. Application Data
(60) Provisional application No. 60/969,856, filed on Sep. 4, 2007.

(51) Int. Cl. G06F 9/44

(52) U.S. Cl. 719/328

(57) ABSTRACT

A support layer for enabling same accessory support across multiple platforms may be provided for supporting interactions of applications, operating systems, and accessory devices. Cross-platform use and cross-accessory use can be realized by designing accessories and applications to operate with a support layer. The support layer can allow accessories to work on multiple devices without requiring development for the accessory of separate software programs to support the multiple devices. The support layer can also allow applications to interact with different accessories again without requiring development for the applications of separate interfaces to support the different accessories.

### CROSS-REFERENCES TO RELATED APPLICATIONS

This applications claims the benefit of and priority to U.S. Provisional Patent Application No. 60/969,856, filed Sep. 4, 2007 and entitled “Support Layer for Enabling Same Accessory Support Across Multiple Platforms,” the entire disclosure of which is herein incorporated by reference for all purposes.

### FIELD OF THE INVENTION

The present invention relates generally to electronic devices. More particularly, to providing a support layer for enabling same accessory support across multiple platforms.

### BACKGROUND OF THE INVENTION

Electronic devices, such as personal computers, laptops, media players, portable media devices, cellular phones, personal digital assists (PDAs), or the like, are prevalent in today's marketplace. Peripherals and accessories to these electronic devices, such as docking stations and A/V cables, can also be commonplace. As competition in the marketplace of consumer electronics and personal computers becomes ever more heated, consumers have become more demanding in terms of both the functionality and use for electronic devices and their associated accessories.

One function that may be popular with electronic devices, such as media players or portable media devices, can be the storage and playback of content or other media assets, such as music, images, photos, and movies. An electronic device may include a communications interface, such as a serial communication link, that allows a user to upload the content or other media assets for storage. Compression and encoding methods, such as MPEG-standards for audio and video, can result in less storage capacity being required by an electronic device, and making potentially making it more convenient and attractive to store tens of thousands of songs and photos, hours of audio books, and several full-length DVD quality movies. Moreover, multimedia content or other media assets can more easily be obtained from distribution sources, such as via the Internet, hot spots, or other electronic retailers.

Accessories or other peripheral devices can also be used to expand capabilities and usability of an electronic device. In the case of an MP3 player, such as the iPod® made by Apple, Inc of Cupertino, Calif. for example, (or, for that matter, any other digital media playback device), a number of accessories can be connected to the MP3 player to provide extended or desired functionalities, such as audio recording, AM/FM broadcasting, speaker output, or the like that may improve usability of the MP3 player to the user. These accessories can range from simply cables to complex docking stations for interfacing with car audio or home theater systems.

Often, an accessory purchased for one device may not be compatible or interchangeable other types of devices or different versions of the same device. This is because software may have to be written for the accessory and a specific the device in order for the accessory to operate with the device. The software might need to be written with the knowledge of the operating systems, applications, and functionalities provided by the device. Thus, a software developer may often write a particular piece of software for the accessory that can only be used with one device. If the same accessory were to be used with the same device using a different operating system, a different version of the device, or a completely different device, the software developer would likely have to design and code a new piece of software to support the different platform combinations. This may be time-consuming and expensive.

Accordingly, what is desired are improved methods and apparatus for solving some of the problems discussed above. Additionally, what is desired are improved methods and apparatus for reducing some of the drawbacks discussed above.

### BRIEF SUMMARY OF THE INVENTION

In various embodiments, a support layer can be provided that enables an accessory to easily be used across multiple platforms. The support layer may function as an intermediary between various software layers on an electronic device. Cross platform use can be realized by designing the accessory (e.g., the accessories software or driver) to operate with the support layer, which enables the accessory to work on multiple devices without requiring development for the accessory of separate software programs to support the multiple devices.

In some embodiments, the support layer can provide bidirectional communication between high level software (such as applications) and low level software (such as an accessory protocol layer that may be used to communicate with an accessory). The support layer may provide the bidirectional communication to permit an accessory to access, for example, a media playback application. The support layer may provide the bidirectional communication to permit an application to access functionality (e.g., a display) associated with an accessory.

A further understanding of the nature and the advantages of the inventions disclosed herein may be realized by reference of the remaining portions of the specification and the attached drawings.

### BRIEF DESCRIPTION OF THE DRAWINGS

In order to better illustrate and describe examples and/or embodiments of those inventions found within the specification, reference may be made to the accompanying drawings. The additional details used to describe the accompanying drawings should not be considered as limitations to the scope of any of the disclosed inventions, the presently described examples and/or embodiments of the inventions, and/or the presently understood best mode of the inventions.

FIG. 1 is a block diagram of a media player that may incorporate embodiments of the present invention;

FIG. 2 is a block diagram of a system including a support layer for enabling same accessory support across multiple platforms in one embodiment according to the present invention;

FIG. 3 is a simplified flowchart of a method for enabling same accessory support across multiple platforms in one embodiment according to the present invention;

FIG. 4 is a block diagram of an system including a software support layer for enabling same accessory support across multiple platforms in one embodiment according to the present invention;

FIG. 5 is a block diagram of components associated with the software support layer of FIG. 4 in one embodiment according to the present invention;

FIG. 6 is a flowchart of a method for accessing media services from an application using a software support layer in one embodiment according to the present invention;

FIG. 7 is a flowchart of a method for accessing application information from an accessory using a software support layer in one embodiment according to the present invention; and

FIG. 8 is a simplified block diagram of a computer system that may incorporate embodiments of the present invention.

### DETAILED DESCRIPTION OF THE INVENTION

In various embodiments, an accessory can be supported across multiple different platforms or hardware configurations using a support layer. Cross platform use can be realized by designing the accessory (e.g., the accessory's software or driver) to operate with the support layer, which enables the accessory to work on multiple devices without requiring development for the accessory of separate software programs to support the multiple devices. The support layer can act as an intermediary between the accessory and software layers (e.g., applications and operating systems) of the different platforms or hardware configurations to which the same accessory may be attached. Thus, the support layer can be provided to enable an accessory to easily be used across multiple platforms.

In some embodiments, the support layer can provide bidirectional communication between high level software (e.g., applications) and low level software (e.g., an accessory protocol layer or driver). The support layer may permit an accessory to communicate in a bidirectional manner with, for example, a media playback application. This allows the accessory to access functionalities associated with the media playback application and the media playback application to access functionalities associated with the accessory. For example, the support layer may provide the bidirectional communication to permit an application to access functionality (e.g., a display) associated with an accessory.

Aspects of some of the environments within which various examples and/or embodiments of those invention found within the specification operate will first be described.

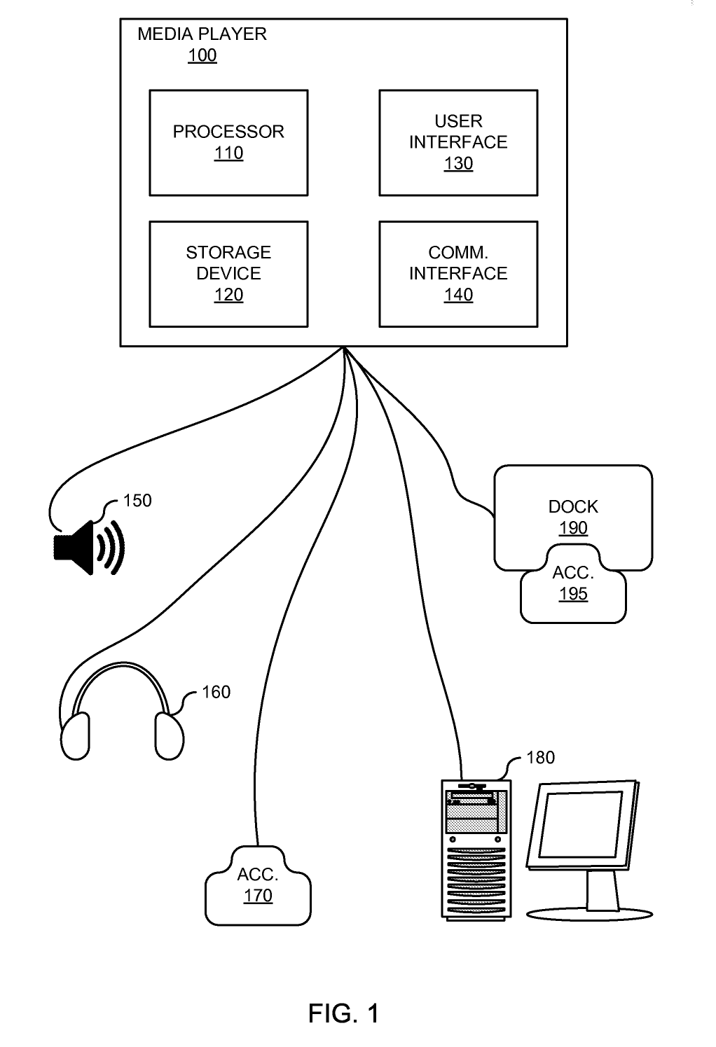

FIG. 1 is a block diagram of media player 100 that may incorporate embodiments of the present invention. In general, a media player stores content and/or media assets, such as audio tracks, movies, or photos that can be played or displayed on the media player. One example of media player 100 can be the iPod® media player, which is available from Apple, Inc. of Cupertino, Calif. Another example of media player 100 can be a personal computer, such as a laptop or desktop.

In this example, media player 100 includes processor 80, storage device 120, user interface 130, and communications interface 140. Processor 80 can control various functionalities associated with media player 100. Media play 100 may output audio content, video content, image content, and the like. Media player 100 may also output metadata or other information associated with content, such as track information and album art.

Typically, a user may load or store content onto media player 100 using storage device 120. Storage device 120 can include read-only memory (ROM), random access memory (RAM), non-volatile memory, flash memory, floppy disk, hard disk, or the like. A user may interact with user interface 130 of media player 100 to view or consume content. Some examples of user interface 130 can include buttons, click wheels, touch pads, displays, touch screens, and other input/output devices.

Media player 100 can include one or more connectors or ports that can be used to load content, retrieve content, interact with applications running on media player 100, interface with external devices, and the like. In this example, media player 100 includes communications interface 140. Some examples of communications interface 140 can include universal serial bus (USB) interfaces, IEEE 1394 (or FireWire/iLink®) interfaces, universal asynchronous receiver/transmitters (UARTs), wired and wireless network interfaces, transceivers, and the like. Media player 100 may connect to devices, accessories, private and public communications networks (e.g., the Internet), or the like, using communications interface 140.

In one example, media player 100 can be coupled via a wired and/or wireless connector or port to output audio and/or other information to speakers 150. In another example, media player 100 may be coupled via a wired and/or wireless connector or port to output audio and/or other information to headphones 160. In yet another example, media player 100 may be coupled via a wired and/or wireless connector or port to interface with an accessory 170 or a host computer 180. The same connector or port may enable different connections at different times.

Media player 100 can be physically inserted into docking system 190. Media player 100 may be coupled via a wired and/or wireless connector or port to interface with docking system 190. Docking system 190 may also enable one or more accessory devices 195 to couple with wires or wirelessly to interface with media player 100. Many different types and functionalities of accessory devices 170 and 195 can interconnect to or with media player 100. For example, an accessory may allow a remote control to wirelessly control media player 100. As another example, an automobile may include a connector into which media player 100 may be inserted such that an automobile media system can interact with media player 100, thereby allowing media content stored on media player 100 to be played within the automobile.

In various embodiments, media player 100 can receive content or other media assets from a computer system (e.g., host computer 160). The computer system may serve to enable a user to manage media assets stored on the computer system and/or stored on media player 100. As an example, communications interface 140 may allow media player 100 to interface with host computer 160. Host computer 160 may execute a media management application to manage media assets, such as loading songs, movies, photos, or the like, onto media player 100. The media management application may also create playlists, record or rip content, schedule content for playback or recording, or the like. One example of a media management application can be iTunes®, produced by Apple, Inc. of Cupertino, Calif.

In various embodiments, a software support layer may be provided that enables an accessory (e.g., a microphone recorder, A/V cable, docking station, etc.) to easily be used across different platforms (e.g., embedded portable electronic devices such as the iPod® and iPhone®) in embodiments of media player 100. The software support layer can provide a consistent set of services for bidirectional communication between both applications and accessories, independent of the hardware/software platform or the operating system of the electronic device on which the software support layer may be executed.

The bidirectional communication provided through the consistent set of services of the software support layer can provide functionality apart from typical abstraction layers that simply may hide particular operating system implementations of low-level interfaces to hardware and low-level services from applications. The software support layer can facilitate communication between applications and peripheral devices or accessories, which often may be very hardware and operating system dependent.

A software support layer, according to various embodiments, may function as an intermediary between software layers and accessories on an electronic device, independent of the hardware and operating system. For example, the support layer may functionally exist between high and low level software layers. The support layer may provide cross-platform use allowing accessory software to operate with the support layer regardless of the type of electronic device or operating system, which enables an accessory to work on multiple devices without requiring development of multiple separate accessory software programs.

In some embodiments, the software support layer may enable bidirectional communication between high level software (such as applications) and low level software (such as an accessory protocol layer that may be used to communicate with an accessory device). Such bidirectional communication is advantageous because this permits an accessory device to access, for example, a media playback application (which may be a high-level software layer). In one embodiment, the support layer may provide a platform independent method for enabling a peripheral device (i.e., an accessory) access to higher-level media library and playback resources.

In some embodiments, the support layer may additionally provide abstractions underlying operating system services that are used by accessory protocols, for such things as timers, threads, and the like. In one embodiment, media player 100 may incorporate the support layer for implementing access to media library and playback resources. The support layer may be expanded to support additional accessory communication protocols, for such items as Bluetooth headsets for mobile phones, system power/sleep behavior, file system access, and video output control. Thus, the software support layer may effectively hide and/or abstract the mechanisms by which applications access low-level software and hardware features, such as controlling media playback and interacting with accessories, and the mechanisms by which accessories interface with applications and operating system services of an electronic device.

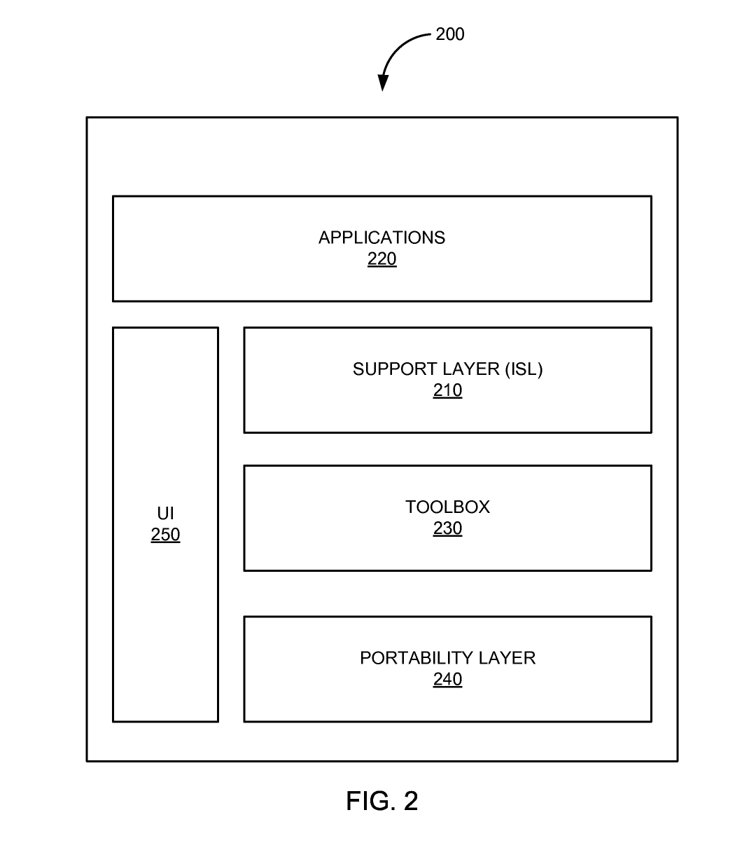

FIG. 2 is a block diagram of a system 200 including a support layer for enabling same accessory support across multiple platforms in one embodiment according to the present invention. System 200 may be embodied as media player 100 of FIG. 1. In this example, system 200 can include support layer (ISL) 210, applications 220, toolbox 230, portability layer 240, and user interface (UI) 250.

ISL 210 can include hardware and/or software elements that enable cross-portability of accessories and applications to multiple hardware platforms and/or multiple operating systems. ISL 210 can be configured to provide one or more interfaces between the high-level software of a device (e.g., applications 220 or UI 250), and the low-level software or services provided by operating systems, drivers, protocol stacks, or the like (e.g., toolbox 230, portability layer 240, or UI 250). In one embodiment, ISL 210 may include a set of classes that expose application specific high-level functionality without ties to a specific user interface framework. The set of classes may include standardized interfaces to common or generalize operations excepted by applications, operating systems, or drivers, such as initialize, uninitialize, save, or the like. The set of classes may expose public functions to carry out application-specific operations. The set of classes may further provide notifications to an application of property or state changes.

In various embodiments, ISL 210 can include hardware and/or software elements configured to route signals, messages, data, and/or other information that may be generated through the standardized interfaces between higher-level software and lower-level software. For example, an external device attached to system 200, such as an accessory, may use ISL 210 to communicate with one or more of applications 220. In another example, the external device may communicate via ISL 210 with a second external device or accessory. Thus, the driver or accessory support software of the external device can be written to use the standard interfaces of ISL 210. This further allows the external device to be used with other electronic devices that incorporate ISL 210, without the driver or accessory support software having to be re-written to support different hardware platforms and/or software applications.

In yet another example, a first of applications 220 may generate a request for information to be sent via ISL 210 to a second of applications 220. In a further example, ISL 210 may interface with hardware and/or software elements of system 200 based on communications with an accessory or application to control features or functionalities associated with system 200, such as buttons, batteries, power management, user interfaces, LEDs, displays, or the like.

Applications 220 can include software elements, such as software programs, executable by a processor or microcontroller. Applications 220 can include software programs that do not form part of an operating system or that require services or functionalities provided by an operating system to execute. In some embodiments, applications 220 may depend upon UI 250 for receiving information from a user and for outputting information to a user. Applications 220 may be configured to interact with ISL 210 to interface with services/information provided by toolbox 230 and/or portability layer 240. For example, applications 220 may be written to call one or more application programming interfaces (APIs) associated with ISL 210. In further embodiments, applications 220 may interact directly with toolbox 230 and portability layer 240.

In one example, applications 220 may interact with ISL 210 by making calls or requests to ISL 210 for system services, to access content (e.g., music and videos stored by media player 100) or content metadata, or the interact with other hardware and/or software elements of an electronic device on which ISL 210 operates. Applications 220 can also receive notifications and/or messages from ISL 210 resulting from the interactions of other hardware and/or software elements of the electronic device with ISL 210. In further embodiments, applications 220 may make calls, send requests, generate notifications, or the like, to toolbox 230 and/or to portability layer 240. The calls, requests, notifications may be made directly or intercepted or routed through ISL 210.

Toolbox 230 can include hardware and/or software elements configured to provide information related to system 200. For example, toolbox 230 may maintain information associated with the status of hardware components of a system 200, such as buttons, LEDs, display backlight settings, battery level remaining, amount of disc free, display size, and the like. Toolbox 230 may include one or more interfaces allowing access to information related to system 200. In one example, toolbox 230 can include interfaces for setting registry information, interfaces for setting features, and other data structures and/or operations that may be used by applications 220 and/or UI 250. Toolbox 230 can be written to interface with ISL 210.

Portability layer 240 can include hardware and/or software elements configured to provide low-level system services. For example, portability layer 240 may include kernel abstraction interfaces, messaging interfaces, file system interfaces, communication interfaces (e.g. FireWire or USB), timers, system calls, interrupts, or the like. Portability layer 240 may be written to interface with ISL 210.

UI 250 can include hardware and/or software elements configured to provide a user interface. UI 250 may include one or more output devices, such as an LED display, one or more visual displays, audio output, graphical user interfaces, audio user interfaces, graphical toolkits, widgets, or the like. UI 250 may further include one or more input devices, such as a click wheel, multi-touch interface, bio-metric interface, or the like. UI may receive input from a user and output information to devices, such as printers, force-feedback, or the like. UI 250 may be written to interface with ISL 210.

In one example of operation, ISL 210 can manage and arbitrate access to resources associated with system 200 that are needed by applications 220. Some examples of resources are accessories or external devices attached to system 200, databases, alarms, timers, system calls, interrupts, hardware specific modules, kernel resources, or the like. ISL 210 may enable bidirectional communication between applications 220 and the low level software or hardware resources (such as toolbox 230 and/or portability layer 240). Thus, a software application may be written once to interact with ISL 210 to access, for example, a media library (which may be another high-level software program). The software application may further interact with ISL 210 to access, for example, registry information associated with a media player (which may be provided by a low-level hardware and/or software elements).

In another example of operation, ISL 210 can manage and arbitrate access to resources associated with system 200 that are needed or requested by an accessory or peripheral device. ISL 210 may enable bidirectional communication between the accessory and high/low level software or hardware resources (such as toolbox 230 and/or portability layer 240). Thus, a software application or driver supporting the accessory may be written once to interact with ISL 210 to access, for example, a media playback application. An accessory protocol program or driver supporting the accessory may further interact with ISL 210 to access, for example, registry information or hardware state information associated with a media player.

ISL 210 can provide abstractions underlying operating system services that are used by accessory protocols or drivers, for such things as timers, threads, or the like. Thus, ISL 210 may effectively hide and/or abstract the mechanisms by which applications access low-level software and hardware features, such as controlling media playback, and by which accessories interface with applications and services provided by an electronic device.

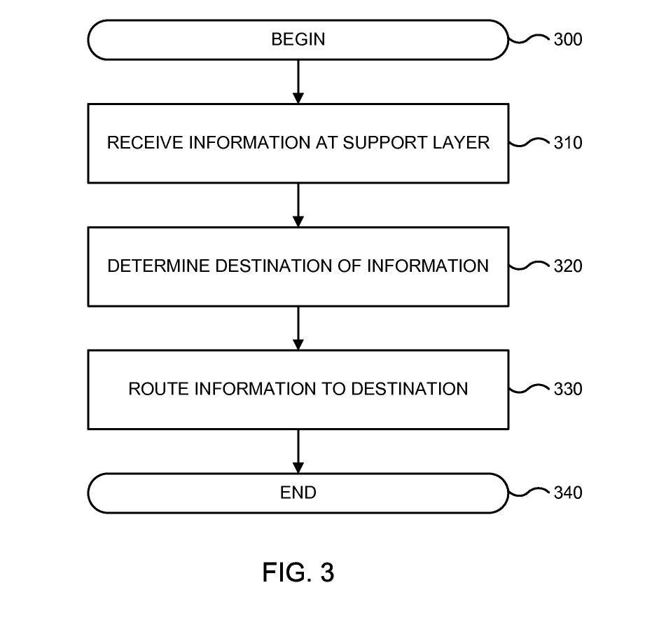

FIG. 3 is a simplified flowchart of a method for same accessory support across multiple platforms in one embodiment according to the present invention. The processing depicted in FIG. 3 may be performed by software modules (e.g., instructions or code) executed by a processor of system 200, by hardware modules, or combinations thereof. FIG. 3 begins in step 300.

In step 310, information is received at a software support layer (e.g. ISL 210 of FIG. 2). For example, ISL 210 may receive information specifying a request for system services, media playback services, or the like, from one of applications 220. In another example, ISL 210 may receive information specifying a request from an external device or accessory to access a functionalities provided by an electronic device, such as one or more of applications 220, system services provided by toolbox 230 and/or portability layer 240, or the like. In yet another example, ISL 210 may receive a message or notification.

In step 320, ISL 210 determines the destination of the information. The destination may include an application, an operating system server, a hardware module, an accessory, or the like. For example, ISL 210 may determine which of applications 220 to route a specific request for information. In another example, ISL 210 may determine to route the information to toolbox 230 and/or portability layer 240. In various embodiments, ISL 210 includes code modules or software elements for specific applications with which ISL 210 can interact and/or hardware platforms on which ISL 210 may reside. ISL 210 may determine which applications, operating systems, or hardware features are available and the correspondence functionalities that they may provide. Requests for functionalities, system services, communications, or the like made using the standardized interfaces of ISL 210 can be routed to the appropriate code modules or software elements for the identified applications, operating systems, or hardware features.

In step 330, ISL 210 routes the information to the determine destination. The information may be routing using a messaging bus, common bus, inter-process communication, pipes, or the like. In one example, ISL 210 may forward the information unmodified to the determine destination. In another example, ISL 210 may format the information according to a generic format, or a predetermined specification for accessing the determine destination. In a further example, ISL 210 may translate the information to be readable by the determined destination. FIG. 3 ends in step 340.

In various embodiments, an accessory such as an A/V cable, may be attached to system 200. System 200 may support one or more accessory protocols that allow system 200 to access various features and functionalities associated with a plurality of accessories and the plurality of accessories to access various features and functionalities associated with system 200. One example of an accessory protocol is referred to as iPod Accessory Protocol (iAP), which is available from Apple, Inc. of Cupertino, Calif. The accessory protocol may includes commands or which have been made accessible to accessory developers. An accessory may initiate a handshake in order to authenticate with system 200. The accessory may announce which accessory protocol it speaks or system 200 may provide a list of available accessory protocols.

The accessory may perform one or more transactions based on services required by the accessory. For example, the A/V cable may request that audio and/or video signals be routed between system 200 and the A/V cable. In another example, the AV cable may attempt to manipulate the volume of an audio signal. In a still further example, accessory may generate a request to switch to a remote user interface mode. The accessory may also generate request for content, or contact playback services.

In various embodiments, ISL 210 can operate as an intermediary to manage and route requests for services required by the accessory. The request may be routed to applications (both high-level and low-level) and to an operating system of system 200. ISL 210 further may operate to route content, information, notifications, messages, or the like from the applications and the operating system of system 220 to the accessory.

In various embodiments, ISL 210 can perform the routing of content, such as audio and video data/signals, to applications and to accessories attached to system 200. In some embodiments, ISL 210 may handle cross talk between a plurality of applications resident on system 220.

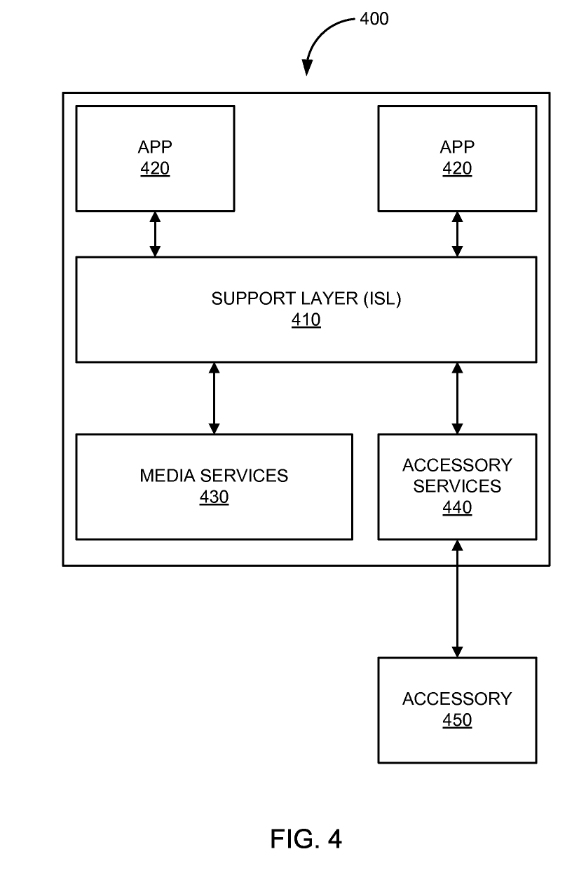

FIG. 4 is a block diagram of system 400 including a software support layer (ISL) 410 for enabling same accessory support across multiple platforms in one embodiment according to the present invention. System 400 may be embodied as media player 100 of FIG. 1. In this example, system 400 can include ISL 410, one or more applications 420, media services 430, accessory services 440, and an accessory 450.

ISL 410 can include hardware and/or software elements configured to provide cross-platform support for applications and accessories. ISL 410 can presented standardized interfaces to applications 420, media services 430, and accessory services 440 that enable bidirectional communication.

In general, media services 430 may include hardware and/or software elements that provide one or more services associated with content or other media assets. In one example, media services 430 may include functions and/or interfaces for initiating playback of content, such as audio files and movies, and interacting with the content. In another example, media services 430 includes functions and/or interfaces for displaying and manipulating content or other media assets, such as images and photos. In a further example, media services 430 may include functions and/or interfaces for accessing and editing metadata associated with content or other media assets. Media services 430 may include interfaces for accessing content or content metadata stored in a content library.

Accessory services 440 can include hardware and/or software elements that allow electrical devices, such as accessory 450, and to be attached to communicate with system 400. Accessory services 440 may include protocols, such as the iPod Accessory Protocol (iAP). Some examples of accessory 450 are microphones, speakers, headphones, cables, headsets, cameras, telephones, cell phones, PDAs, radio tuners, TV tuners, docking stations, automobiles, or the like.

In one example of operation, ISL 410 can provide bidirectional communication between one of applications 420 and accessory 450. ISL 410 may provide bidirectional communication between a first of applications 420 and a second of applications 420.

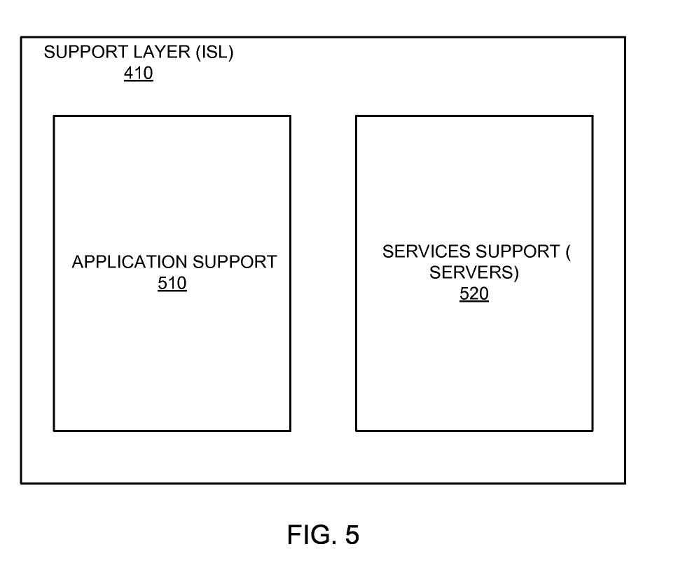

FIG. 5 is a block diagram of components associated with the software support layer (ISL) 410 of FIG. 4 in one embodiment according to the present invention. In this embodiment, ISL 410 can include application support 510 and services support (servers) 520.

Application support 510 can include hardware and/or software elements configured to provide an interface to one or more applications. Application support 510 can include interfaces, methods, procedures, or the like that encompass in a standardized or generic form application or feature specific behavior. Furthermore, application support 510 may include functionality that is not tied to the specific hardware and/or user interface elements. In one example, application support 510 can include interfaces to radio functionality, music player functionality, video player functionality, or the like provided by one or more applications.

Services support (servers) 520 can include hardware and/or software elements configured to provide an interface to low-level hardware and/or software elements. For example, services support 520 may include interfaces in a standardized of generic form to one or more accessory communication protocols, volume services, video display services, media services, storage services, alarm services, dispatching services, operating system APIs, or the like.

Accordingly, application support 510 and services support (servers) 520 can provide access to functionalities, functions, notifications, and properties to applications and/or external devices/accessories regardless of the underlying operating system or hardware platform. Some examples of the interfaces provided by ISL 410 include address book, calendars, content database access, media filtering, media playback, photo caching, photo import, radio, speakers, settings, voice recorder, volume, world clock, or the like. Some examples of functions are initialize, un-initialize, suspend, wake, load data, save data, unload data, or the like. Some examples of notifications are signals, messages, instructions, interrupts, or the like. Some examples of properties are binary indicators, values, strings, structured and unstructured data, or the like.

In one embodiment, application support 510 can include an interface to functions related to a radio player. For example, application support 510 may include functions for enabling or disabling a radio, setting are getting a frequency, setting or getting a frequency range, setting or getting a preset list, tuning to a preset, scanning forward and backwards, getting information broadcast along with a radio signal, and determining whether a radio is attached. Application support 510 may further include helper functions that jump forward and or backwards to a preset, get and set a region code, and toggle presets representing state associated with the radio player. Additionally, application support 510 may generate notifications, such as whether the radio is attached, whether the radio becomes detached, whether data associated with a radio signal changes, whether tuning to a station has been completed, whether a scan has been completed, and the like. Furthermore, application support 520 may provide properties, such as the state of the radio, a tuned frequency, a frequency range, a preset list, information broadcast with a radio signal, a current region, and the like.

In some embodiments, ISL 410 of system 400 may further provide interfaces related to how external devices view system 400 as a storage device. For example, system 400 may operate in a disk mode allowing system 400 to be treated as a storage disk. Accordingly, ISL 410 may provide that different devices having different operating systems using ISL 410 may appear to a host computer as the same type of storage device.

In further embodiments, ISL 410 may further provide power management services. For example, ISL 410 may retrieve power system status, such as power state, battery level, battery connected state, connected to charger state, and the like. ISL 410 may generate notifications in response to changes in the power management status.

Accordingly, ISL 410 can be implemented to provide codesharing between multiple devices using multiple operating systems. Furthermore, ISL 410 can be implemented to provide a virtual interface for accessing system services of multiple devices using multiple operating systems. In various embodiments, ISL 410 can be implemented to provide a thread abstraction, access to system services, and high-level access to applications from accessories. Thus, the same accessory may be used with multiple devices without recoding accessory support for the accessory when different operating systems are present or different device configurations are present.

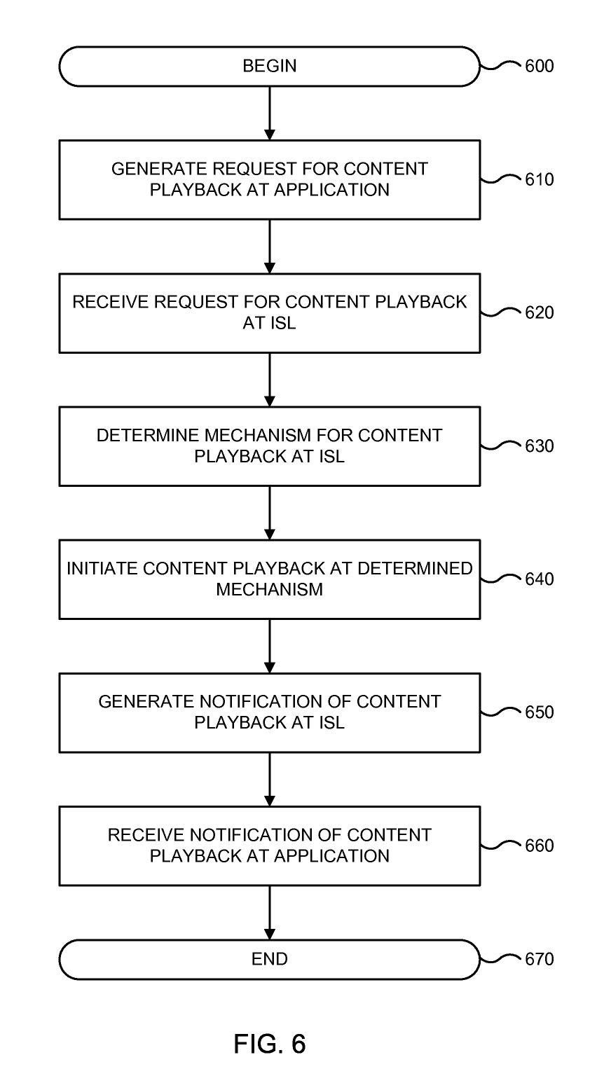

FIG. 6 is a flowchart of a method for accessing media services from an application using a software support layer in one embodiment according to the present invention. FIG. 6 begins in step 600.

In step 610, a request for content playback is generated at an application. For example, an application may generate a request to playback a song, movie, and the like. In step 620, the request for content playback is received at a software support layer (e.g., ISL 410 of FIG. 4).

In step 630, a mechanism for content playback is determined at the software support layer. For example, the software support layer may determine that the function of content playback is performed by a media playback application. In another example, the software support layer may determine that the function of content playback is performed by a hardware component. In step 640, content playback is initiated at the determined mechanism.

In step 650, and notification is generated at the software support layer of the content playback. For example, the software support layer may generate a signal to the requesting application indicating that playback of the content has begun. In another example, the software support layer may generate a message to the application indicating that playback of the content has begun. In step 660, notification of content playback is received at the application. FIG. 6 ends in step 670.

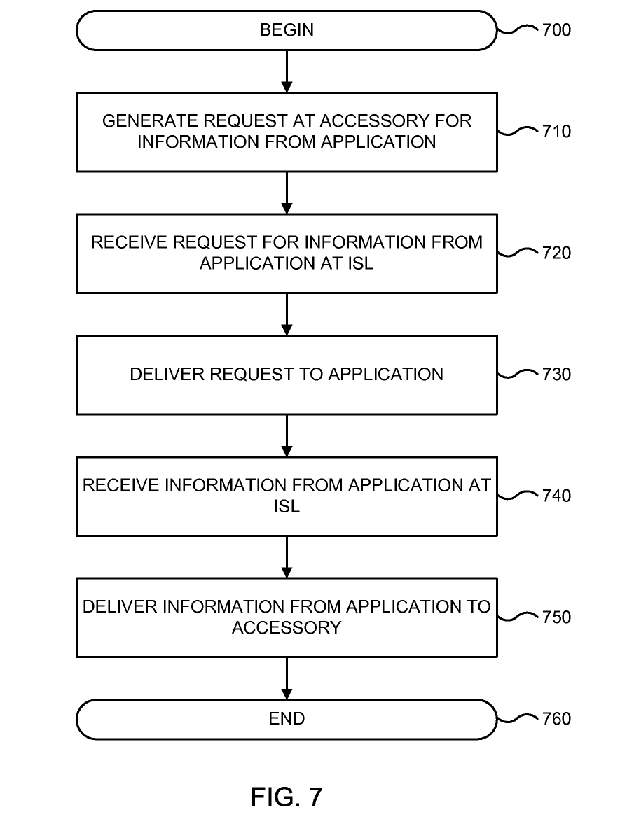

FIG. 7 is a flowchart of a method for accessing application information from an accessory using a software support layer in one embodiment according to the present invention. In begins in step 700.

In step 710, a request is generated at an accessory for information from an application. In step 720, the request for information from an application is received at a software support layer (e.g., ISL 410 of FIG. 4).

In step 730, the request is delivered to the application. In step 740, information from the application is received at the software support layer. For example, the accessory may request track information associated with a music file. The software support layer may deliver the request to a music library, which retrieves track information associated with the music file and delivers the information to the software support layer.

In step 750, information from the application is delivered to the accessory. Continuing the previous example, the software support layer then may route the track information retrieved from the media library to the accessory. FIG. 7 ends in step 760.

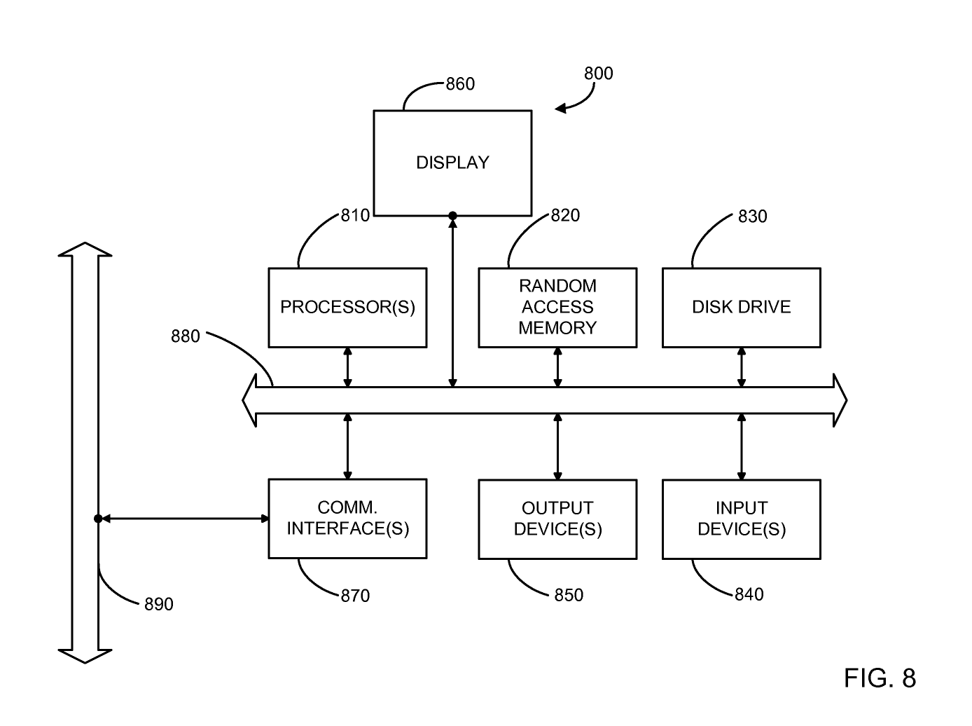

FIG. 8 is a simplified block diagram of a computer system 800 that may incorporate embodiments of the present invention. FIG. 8 is merely illustrative of an embodiment incorporating the present invention and does not limit the scope of the invention as recited in the claims. One of ordinary skill in the art would recognize other variations, modifications, and alternatives.

In one embodiment, computer system 800 includes processor(s) 810, random access memory (RAM) 820, disk drive 830, input device(s) 840, output device(s) 850, display 860, communications interface(s) 870, and a system bus 880 interconnecting the above components. Other components, such as file systems, storage disks, read only memory (ROM), cache memory, codecs, and the like may be present.

RAM 820 and disk drive 830 are examples of tangible media configured to store data such as audio, image, and movie files, operating system code, embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In various embodiments, input device 840 is typically embodied as a computer mouse, a trackball, a track pad, a joystick, a wireless remote, a drawing tablet, a voice command system, an eye tracking system, a multi-touch interface, a scroll wheel, a click wheel, a touch screen, an FM/TV tuner, audio/video inputs, and the like. Input device 840 may allow a user to select objects, icons, text, and the like, via a command such as a click of a button or the like. In various embodiments, output device 850 is typically embodied as a display, a printer, a force-feedback mechanism, an audio output, a video component output, and the like. Display 860 may include a CRT display, an LCD display, a Plasma display, and the like.

Embodiments of communications interface 870 may include computer interfaces, such as include an Ethernet card, a modem (telephone, satellite, cable, ISDN), (asynchronous) digital subscriber line (DSL) unit, FireWire interface, USB interface, and the like. For example, these computer interfaces may be coupled to a computer network 890, to a FireWire bus, or the like. In other embodiments, these computer interfaces may be physically integrated on the motherboard or system board of computer system 800, and may be a software program, or the like.

In various embodiments, computer system 800 may also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer system 800 may also include an operating system, such as Microsoft Windows®, Linux®, Mac OS X®, real-time operating systems (RTOSs), open source and proprietary OSs, and the like.

FIG. 8 is representative of a media player and/or computer system capable of embodying the present invention. It will be readily apparent to one of ordinary skill in the art that many other hardware and software configurations are suitable for use with the present invention. For example, the media player may be a desktop, portable, rack-mounted or tablet configuration. Additionally, the media player may be a series of networked computers. Moreover, the media player may be a mobile device, an embedded device, a personal digital assistant, a smart phone, and the like. In still other embodiments, the techniques described above may be implemented upon a chip or an auxiliary processing board.

The present invention can be implemented in the form of control logic in software or hardware or a combination of both. The control logic may be stored in an information storage medium as a plurality of instructions adapted to direct an information-processing device to perform a set of steps disclosed in embodiments of the present invention. Based on the disclosure and teachings provided herein, a person of ordinary skill in the art will appreciate other ways and/or methods to implement the present invention.

The embodiments discussed herein are illustrative of one or more examples of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, the present descriptions and drawings should not be considered in a limiting sense, as it is understood that the present invention is in no way limited to only the embodiments illustrated.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for enabling an accessory device to interact with a plurality of electronic devices having different software configurations, the method comprising:
receiving, using a software support layer in a software stack of an electronic device linked to the accessory device, an application request from a first software layer in the software stack indicative of the accessory device calling a function of an application in a second software layer above the first software layer in the software stack;
determining, using the software support layer, which application in the second software layer of the electronic device to service the call in the application request; and
delivering, using the software support layer, the application request to the determined application in the second software layer of the electronic device.

2. The method of claim 1 wherein determining, using the software support layer, which application in the second software layer of the electronic device to service the call in the application request comprises:
determining a desired application functionality based on the function; and
determining an application in the second software layer that provides the desired application functionality.

3. The method of claim 1 wherein receiving the application request from the first software layer comprises receiving a request from an accessory protocol layer associated with the accessory device to interact with an application of the electronic device.

4. The method of claim 1 wherein receiving the application request from the first software layer comprises receiving a request from a device driver associated with the accessory device to interact with an application of the electronic device.

5. The method of claim 1 wherein receiving the application request from the first software layer comprises receiving a request from an accessory protocol layer associated with the accessory device to interact with an operating system of the electronic device.

6. The method of claim 1 wherein the application request comprises a request for media playback.

7. The method of claim 1 wherein the application request comprises a request for one or more operating system services.

8. A computer-readable storage medium configured to store a set of code modules executable by a processor of a media playback device, the computer-readable storage medium comprising:
code for loading a media playback application into a memory of the media playback device;
code for loading a software support layer into the memory of the media playback device;
code for loading an accessory protocol layer for accessory devices configured to be communicatively coupled to the media playback device into the memory of the media playback device;
code for using the software support layer to intercept from the accessory protocol layer an application request indicative of an accessory device calling a media playback function;
code for using the software support layer to determine whether the media playback application provides the media playback function to service the call in the application request; and
code for using the software support layer to deliver the application request from the accessory protocol layer to the media playback application.

9. The computer-readable storage medium of claim 8 wherein the code for using the software support layer to intercept from the accessory protocol layer an application request comprises code for intercepting a request from a device driver associated with the accessory device.

10. The computer-readable storage medium of claim 8 wherein the code for using the software support layer to intercept from the accessory protocol layer an application request comprises code for receiving a request from the accessory protocol layer for power management services provided by an operating system of the electronic device.

11. The computer-readable storage medium of claim 8 further comprising:
code for using the software support layer to route a status of the media playback function from the media playback application to the accessory protocol layer.

12. A method for enabling electronic devices having different software configurations to interact with an accessory device, the method comprising:
receiving, using a software support layer in a software stack of an electronic device to which the accessory device is communicatively coupled, an accessory request from a first software layer in the software stack indicative of an application calling a function of an accessory device in a second software layer below the first software layer in the software stack;
determining, using the software support layer, that software for the accessory device in the second software layer of the electronic device will service the call in the accessory request; and
delivering, using the software support layer, the accessory request to the determined software for the accessory in the second software layer of the electronic device.

13. The method of claim 1 wherein determining, using the software support layer, that software for the accessory device in the second software layer of the electronic device will service the call in the accessory request comprises:
determining a desired accessory functionality based on the function; and
determining that the software for the accessory device in the second software layer provides the desired accessory functionality.

14. The method of claim 1 wherein receiving the accessory request from the first software layer comprises receiving a request from an application associated with the electronic device to interact with the accessory device communicatively coupled to the electronic device.

15. The method of claim 1 wherein receiving the accessory request from the first software layer comprises receiving a request from an operating system associated with the electronic device to interact with the accessory device communicatively coupled to the electronic device.

16. The method of claim 1 wherein the accessory request comprises a request to update a display associated with the accessory device.

17. The method of claim 1 wherein the accessory request comprises a request to configure one or more components of the accessory device.

18. A computer-readable storage medium configured to store a set of code modules executable by a processor of a portable media player, the computer-readable storage medium comprising:
code for loading one or more operating system services into a memory of the portable media player;
code for loading a software support layer into the memory of the portable media player;
code for loading an accessory protocol layer for accessory devices configured to be communicatively coupled to the portable media player into the memory of the portable media player;
code for using the software support layer to intercept an accessory request from the one or more operating system services calling the accessory protocol layer;
code for using the software support layer to determine an accessory device that will service the call in the accessory request; and
code for using the software support layer to deliver the accessory request from the one or more operating system services to the accessory protocol layer.

19. The computer-readable storage medium of claim 18 wherein the code using the software support layer to intercept an accessory request from the one or more operating system services comprises code for intercepting a request to configure a transceiver associated with the accessory device.

20. The computer-readable storage medium of claim 18 wherein the code using the software support layer to intercept an accessory request from the one or more operating system services comprises code for intercepting a request from a power management application to power down the accessory device.

21. The computer-readable storage medium of claim 18 wherein the code using the software support layer to intercept an accessory request from the one or more operating system services comprises code for intercepting a request from a power management application to store media data on the accessory device.

22. A method for enabling bi-directional communication between an accessory device and a plurality of electronic devices having different software configurations, the method comprising:
providing a software support layer in a software stack of at least one of the plurality of electronic devices to which the accessory device is linked;
in response to an application request from an accessory protocol layer in the software stack indicative of the accessory device calling a function of an application in an application software layer above the accessory protocol layer in the software stack, determining an application of the electronic device in the application layer to service the call in the application request and delivering the application request to the application using the software support layer; and
in response to an accessory request from the application in the application layer indicative of the application calling a function of an accessory device in the accessory protocol layer, determining that the accessory device will service the call in the accessory request and delivering the accessory request to the accessory protocol layer using the software support layer.

23. The method of claim 22 further comprising:
routing messages between the application layer and the accessory support layer using the software support layer.

24. The method of claim 22 further comprising:
loading the application into a memory associated with the electronic device; and
registering a set of functions provided by the application with the software support layer.

25. The method of claim 22 further comprising:
registering a set of functions provided by the accessory device with the software support layer using the accessory protocol layer.
